(19) United States
(12) Patent Application Publication
(10) Pub. No.: US 2007/0024427 A1
(43) Pub. Date: Feb. 1, 2007

(54) Electronic device

(75) Inventors: Yoichiro Sako, Tokyo (JP); Kenichi Makino, Kanagawa (JP); Motoyuki Takai, Tokyo (JP); Yasushi Miyajima, Kanagawa (JP); Katsuya Shirai, Kanagawa (JP); Makoto Inoue, Kanagawa (JP); Toshiro Terauchi, Tokyo (JP); Akiko Inoue, Saitama (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/569,806

(22) PCT Filed: Aug. 31, 2004
(86) PCT No.: PCT/JP04/12556

§ 371 Date: Feb. 27, 2006

(30) Foreign Application Priority Data
Sep. 9, 2003 (JP) 2003-317480

(51) Int. Cl. G08B 1/00

(52) U.S. Cl. 340/309.6

(57) ABSTRACT

Disclosed is an electronic apparatus having its operation controlled electronically responsive to the wax and the wane of the moon. The electronic apparatus includes a moon age calendar (4) for storage of the age of the moon, a timer (3) for timing the current date and time, and an image database (5) for storage of moon images. A display controller (6) retrieves the age of the moon, consistent with the current date of time, from the moon age calendar (4), and reads out a moon image of the moon phase consistent with the age of the moon from the image database (5). An operating panel (9) includes a display area for demonstrating the operating state of the electronic apparatus and another display area for demonstrating the wax and the wane of the moon. The display controller (6) causes the moon image to be read out from an image database (5) and demonstrated in the display area for demonstrating the wane of the moon.

### TECHNICAL FIELD

This invention relates to an electronic device having its operation controlled electronically responsive to the wax and wane of the moon.

The present invention contains subject matter related to Japanese Patent Application JP 2003-317480, filed on Sep. 9, 2003, the entire contents of which being incorporated herein by reference.

### BACKGROUND ART

In general, the behavior of the human being or the plants and animals is said to be related with the wax and the wane of the moon. It has actually been demonstrated that the heart rate of the stressed human being or animals is increased as the new moon or the full moon is approached. Hence, the wax and the wane of the moon may become a measure for grasping the state of the human being. Consequently, the changes in the status of one's self caused by the wax and the wane of the moon may be known through observation of the wax and the wane of the moon.

However, in our everyday life of these days, the moon may not be viewed due to the high-rise building or the wall of the living space obstructing our field of view. In addition, we spend much time in viewing television broadcast or listening to music, as entertainment, while we cannot afford to spend much time in going outdoors to look up in the sky.

On the other hand, there is disclosed in Japanese Laid-Open Patent Publication Hei-9-15357 a timepiece by which the wax and the wane of the moon can be confirmed without having to look up in the sky. Such timepiece includes a timekeeping means for timing the current time and a position information storage means for holding the user's position on memory, and operates for calculating the hour angle and the age of the moon at a given time from the time information obtained from the timekeeping means and the position information stored in the position information storage means for demonstrating the phase of the moon corresponding to the age of the moon on a display dial.

However, a wrist watch is worn at all times, and is in need of fashionability, as its attribute, and some people may be fond of a wrist watch with a moon image on its dial, while others may not be so. A stand clock is also an interior device and there may be those who are not fond of a stand clock displaying a moon image on its display dial. Even if a moon image small enough in size not to detract from the appearance is displayed on the display dial, there may be only few who would purposely approach to the stand clock to gaze at the mark, such that the moon mark is liable to be overlooked.

### DISCLOSURE OF THE INVENTION

Problem to be Solved by the Invention

It is an object of the present invention to provide an electronic device having its operation controlled electronically responsive to the wax and wane of the moon.

In one aspect, the present invention provides an electronic apparatus, the operations of which are controlled electronically, in which the apparatus comprises main operating means for performing a specified operation consistent with the use of said electronic apparatus, main control means for controlling said main operating means, display means including a main operation display area for demonstrating the operating state of said main operating means and a moon image display area for demonstrating a moon image consistent with the age of the moon, and display control means for demonstrating the operation of said main operating means, output from said main control means, in said main operation display area, and for demonstrating the moon image consistent with the age of the moon in said moon image display area.

In another aspect, the present invention provides an electronic apparatus, the operations of which are controlled electronically, in which the apparatus comprises main operating means for performing a specified operation consistent with the use of said electronic apparatus, moon age acquisition means for acquiring the age of the moon and control means for controlling the operation of said main operating means in keeping with said age of the moon.

With the electronic apparatus, according to the present invention, in which a display area for demonstrating the moon image is provided in a part of display means of the electronic apparatus, a user may routinely grasp the wax and the wane of the moon each time he/she acts on the apparatus. With the electronic apparatus, according to the present invention, in which the operation of the apparatus may be controlled depending on the age of the moon, the user's feeling may be tuned to the wax and the wane of the moon or suppressed taking the wax and the wane of the moon into account.

Other objects and specified advantages of the present invention will become more apparent from the following explanation of preferred embodiments which will now be made with reference to the drawings.

### BRIEF DESCRIPTION OF THE DRAWINGS

FIG. 1 is a block diagram showing a basic configuration of an electronic device according to the present invention.

FIG. 2 is a plan view showing an operating panel and operating buttons.

FIG. 3 is a block diagram showing an inner structure of a television receiver embodying the present invention.

FIG. 4 is a block diagram showing a moon age acquisition unit for calculating the age of the moon.

FIG. 5 is a block diagram showing a moon age acquisition unit to which an age of the moon is entered from outside.

FIG. 6 is a block diagram showing an inner structure of a DVD player embodying the present invention.

### BEST MODE FOR CARRYING OUT THE INVENTION

The present invention is applied to an electronic apparatus having a display part. The electronic apparatus having a display part may be exemplified by a television receiver, a DVD (Digital Versatile Disc) player, an audio reproducing apparatus, an air conditioner, a refrigerator, a washing machine, and a remote controller. According to the present invention, a display area for demonstrating the wax and the wane of the moon is provided in a portion of a display area of the electronic apparatus mentioned above. By providing this display area, it becomes possible for a user to recognize the state of the moon, by visual check, when he/she acts on the electronic apparatus or views an image.

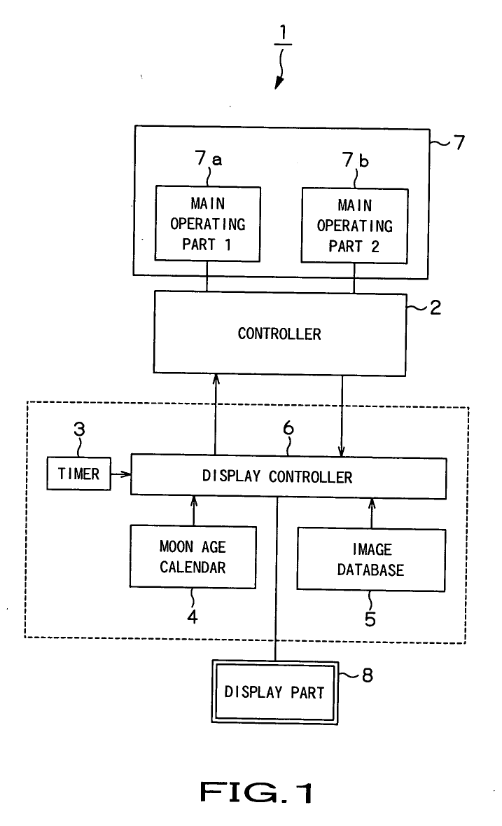

FIG. 1 shows the configuration of an electronic apparatus 1 embodying the present invention. The electronic apparatus 1, shown in FIG. 1, includes a main operating part 7, performing peculiar operations consistent with the use of the electronic apparatus 1, a controller 2 for controlling the operation of the main operating part 7, a moon age calendar 4, having stored the age of the moon, an image database 5, having stored the images of the moon with different phases, a timer 3 for timing the date and the time, and a display controller 6 for displaying the images of the moon on a display part 8.

The main operating part 7 is a block for performing peculiar operations consistent with the usage of the electronic apparatus. For example, when the electronic apparatus is a refrigerator, the main operating part 7 includes a compressor for generating cool air or a temperature sensor for detecting the temperature in the refrigerator, as a main operating part 7a, and an interior fan, not shown, for circulating the air in the refrigerator.

The display controller 6 carries out the processing for calculating or retrieving the age of the moon, the processing for demonstrating a moon image for the particular age of the moon on the display part, and display control processing for demonstrating the operating state of the electronic apparatus or the key inputting operation by the user on the display part 8.

The display controller 6 retrieves the age of the moon, corresponding to the current date and time, from the moon age calendar 4, or takes the difference between the synodic date and time as stated on the moon age calendar and the current date and time to calculate the age of the moon.

Lacking the moon age calendar 4, the display controller 6 substitutes current date and time into a simple mathematical equation {(Y−1740)×210/19−2+M +D}, where Y denotes Christian year, M denotes month and D denotes date, to calculate the age of the moon, or finds the synodic day based on the phase difference between the celestial longitude of the sun and that of the moon to calculate the age of the moon from the days and hours elapsed from the synodic day. The method for calculating the age of the moon or the presence or the absence of the moon age calendar 4 is not relevant to the present invention, and any suitable method for calculating the age of the moon, that may be convenient for the processing capability of the display controller 6 or for the memory capacity, may be used.

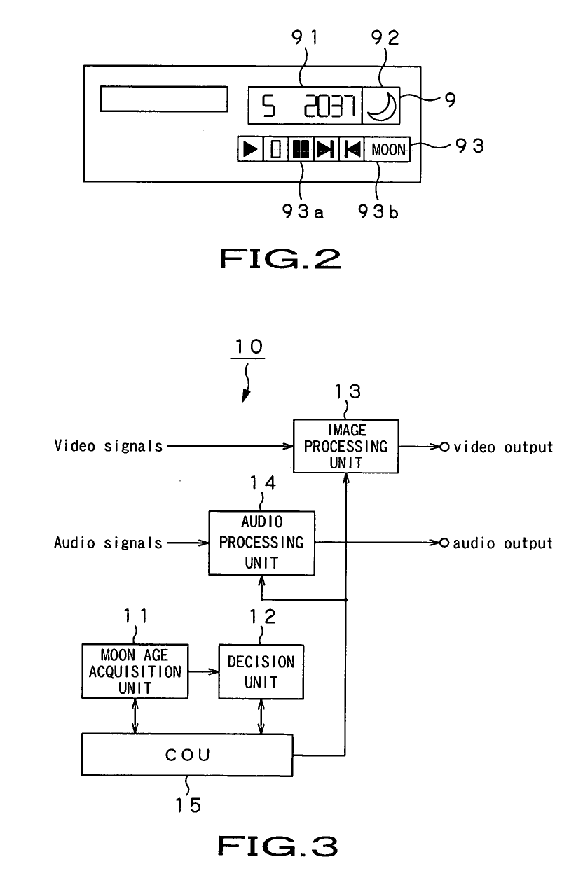

When the age of the moon has been calculated, the display controller 6 reads out the image of the moon for the so calculated age of the moon to demonstrate it on the display part 8. FIG. 2 shows an illustrative image of the moon. This figure shows, as the display part 8, an operating panel 9 of a compact disc player or a DVD player, for example. The operating panel 9 is made up by a display area 91 in which to display the image of the moon, and a main display area 92 for demonstrating the operating state of the electronic apparatus 1 or the key input contents by the user. The display controller 6 demonstrates a status signal, output from the controller 2, or a key input signal, output from an operating button 93, on the main display area 92, while calculating the age of the moon and demonstrating the image of the moon for the so calculated moon age.

The operating button 93, which is a part for accepting a command input from a user, is provided in a lower portion of the operating panel. Similarly to the display area, the operating button 93 is made up by an operating button 93a relevant to actuation of the electronic apparatus and another operating button 93b relevant to the display of the moon image. The display controller 6 accepts the operating signal for the electronic apparatus 1 and the operating signal for displaying the moon image and, responsive to the accepted signals, causes change in the displayed contents.

As described above, the electronic apparatus 1 of the present invention includes the display area 91 in the operating panel 9 and exploits the excess processing capability of the display controller 6 to display the moon image in the display area 91. The age of the moon is said to influence the living activities or emotion of the human being and, by so displaying the age of the moon, the human being is able to comprehend his/her own change retained to be caused by the wax and the wane of the moon. Additionally, with the electronic apparatus 1 of the present invention, the wax and the wane of the moon can be recognized during the daytime or in a bad weather when the moon is not seen. Moreover, the operating panel may be improved in design properties by demonstrating the wax and the wane of the moon.

It should be understood that the present invention is not limited to the above-described embodiment and that any changes or improvements including the purport of the present invention that the image of the moon shall be displayed on the display part 8 of the electronic apparatus are to be included within the present invention. For example, the image of the moon may be generated by the controller 2 instead of by the display controller 6. In addition, if the image of the moon is represented by a display pattern of the liquid crystal, without storing the moon image in the image database 5, the image database 5 may be dispensed with. Furthermore, if the image of the moon or the moon age calendar 4 is acquired from outside over the network, the corresponding storage area in the image database 5 or in the moon age calendar 4 may be dispensed with.

In case the display part 8 of high resolution and broad display area, such as LCD (liquid crystal display) or CRT (cathode-ray tube), is connected to the electronic apparatus 1, it is possible to display a detailed image. In particular, with a personal computer, it is possible to process the image or to input the weather information, over a network, to generate the image of the moon consistent with the weather. Meanwhile, with a DVD player or a video player, it is possible to use not an operating panel but an excess channel of a television receiver as a display area for demonstrating the image of the moon.

The foregoing explanation has been directed to the electronic apparatus for demonstrating the wax and the wane of the moon on the display part 8. The explanation to follow is relevant to an electronic apparatus which not only demonstrates the wax and the wane of the moon but also changes its operating states responsive to the wax and the wane of the moon.

FIG. 3 depicts a block diagram showing the configuration of a television receiver 10. This television receiver 10 includes a moon age acquisition unit 11, for acquiring the age of the moon, a decision unit 12 for giving a decision as to image or audio processing in keeping with the age of the moon, an image processing unit 13 for doing image processing, an audio processing unit 14 for doing audio processing, and a controller 15 for controlling blocks doing operations proper to the television receiver.

The blocks doing operations proper to the television receiver may be exemplified by a frequency synthesizer for converting electrical waves, received by an antenna, into electrical signals, a display processor for doing chroma signal processing for doing chroma signal processing for video signals or for synchronizing signal processing for a picture image, an audio processing unit 14 for taking charge of the surround function or speech demultiplexing for audio signals, and an input converter for taking charge of input switching with e.g. a video tuner or a BS tuner. These blocks are connected to the controller 15, which controller 15 is supplied with status signals from the respective blocks to output control signals consistent with the status of the respective blocks.

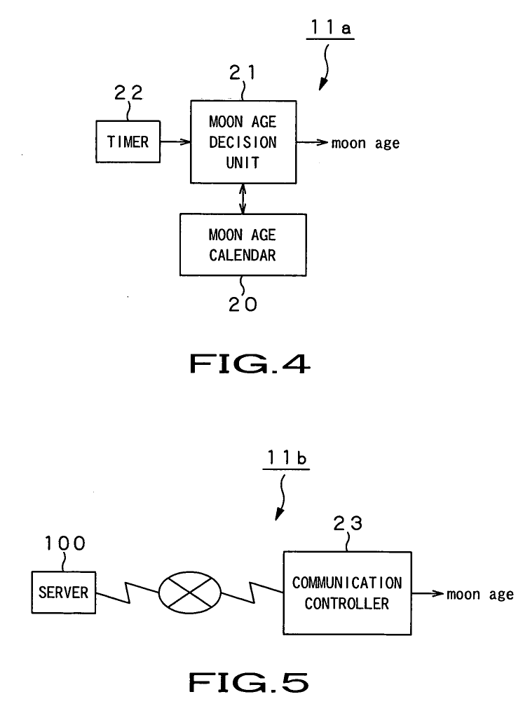

The moon age acquisition unit 11 calculates the moon age or is supplied with it from outside. Figs. 4 and 5 show the configuration of a moon age acquisition unit 11a, for acquiring the age of the moon, and the configuration of a moon age acquisition unit 11b, supplied from outside with the age of the moon, respectively. The moon age acquisition unit 11a, shown in FIG. 4, includes a moon age calendar 20, for memorizing the age of the moon, and a moon age decision unit 21. The moon age calendar 20 has stored therein the date and the moon age correlated with each other, and may be exemplified by a moon age calendar stating the moon age every day and a moon age calendar stating the synodic date and time. With the former type of the moon age calendar, the moon age decision unit 21 retrieves the age of the moon, corresponding to the current date and time, from the moon age calendar. With the latter type of the moon age calendar, the moon age decision unit 21 calculates the age of the moon based on the difference between the synodic date and time and the current date and time. The moon age acquisition unit 11b, shown in FIG. 5, includes a communication controller 23 for connection to an external network and downloads the age of the month or the moon age calendar from a preset server 100 on the external network.

The decision unit 12 decides on the image processing or audio processing suited to the age of the moon. More specifically, when the age of the moon is nearing 15 (full moon), the decision unit 12 performs image processing or audio processing which will calm the frame of mind of the human being, in order to suppress the rise of his/her heart beat directly after new moon or the full moon. The image processing which will calm the frame of mind of the human being may be exemplified by blurring the image edge and decreasing the contrast, while the audio processing which will calm the frame of mind of the human being may be exemplified by decreasing the speech tempo. Conversely, when the age of the moon is nearing the new moon (0), the decision unit performs image processing or audio processing which will excite the frame of mind of the human being. The image processing which will excite the frame of mind of the human being may be exemplified by emphasizing the image edge or increasing the contrast, while the audio processing which will excite the frame of mind of the human being may be exemplified by increasing the speech tempo or emphasizing the high range.

Thus, with the television receiver, embodying the present invention, it is possible to perform image or audio processing, in keeping with the changes in the living activities of the human being, retained to be ascribable to the age of the moon, and to suppress changes in the living body information of the human being or, conversely, or promote such changes.

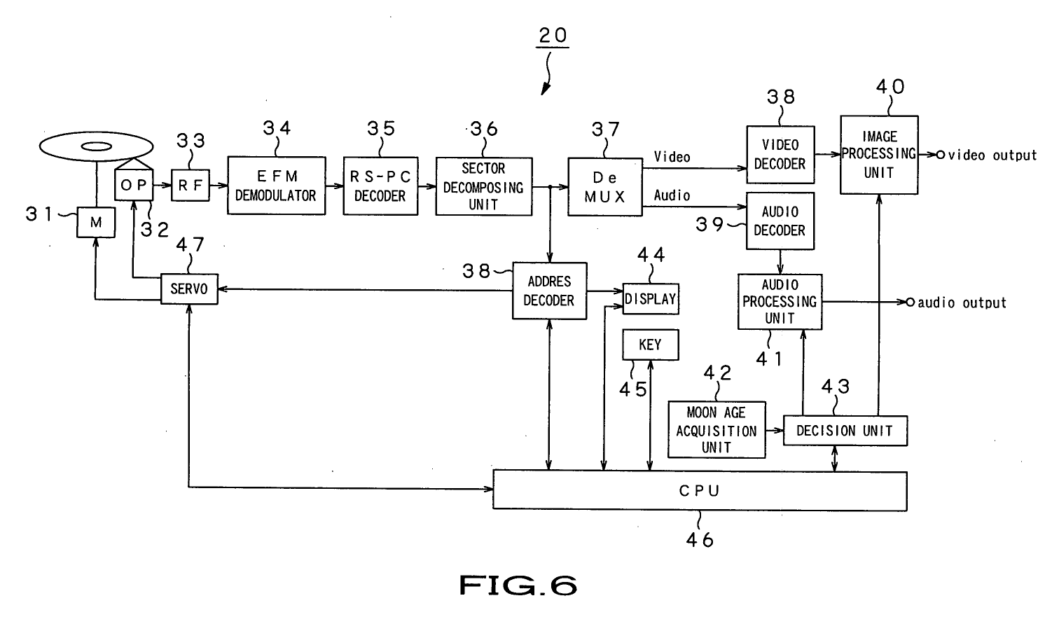

The present invention may also be applied to electronic apparatus other than the television receiver 10. FIG. 6 depicts the configuration of a DVD player 20 embodying the present invention. In FIG. 6, a motor 31 causes rotation of a DVD (Digital Versatile Disc), and an optical pickup 32 reads out the optical information, recorded on the DVD, to convert it into RF signals. An RF amplifier 33 amplifies RF signals to output the so amplified signals to an EFM demodulator 34. This EFM demodulator 34 converts 8-bit RF signals into a 14-bit code. An RS-PC decoder 35 carries out error correction in accordance with the RS-PC (Reed-Solomon Product Code) system. A sector decomposing unit 36 decomposes signals into sectors to route the resulting signals to a demultiplexer unit 37 and to an address decoder 38. This address decoder 38 detects the wobbling frequency in the guide groove of the DVD from input RF signals to read out the address. The address decoder 38 outputs the read-out address to a display 44, a CPU 46 and to a servo 47. The servo 47 controls the motor 31 and displacement of the optical pickup 32, based on an address input from the address decoder 38, RF signals input from the RF amplifier 33 and on the control signal of the CPU 46. On the other hand, the demultiplexer unit 37 decomposes the RF signals, output from the sector decomposing unit 36, into video and audio signals. The video decoder 38 decodes the video signals, in accordance with the MPEG system, while an audio decoder 39 decodes audio signals in accordance with the MPEG system.

In the present invention, an image processing unit 40 is provided downstream of the video decoder 38, and an audio processing unit 41 is provided downstream of an audio decoder 39. The image processing unit 40 performs image processing, such as edge emphasis processing or contrast adjustment, while the audio processing unit 41 performs audio processing, such as audio tempo-up or high range emphasis processing, or dynamics changing processing.

A moon age acquisition unit 42 acquires the age of the moon by any of the methods described above. A decision unit 43 decides on the image processing or the image processing, suited to the age of the moon, and commands the image processing unit 40 and the audio processing unit 41 to carry out the so determined processing. The image processing and the audio processing, suited to the age of the moon, are as explained in the foregoing.

With the television receiver 10 or the DVD player 20, according to the present invention, in which the output of the image or the speech is changed with the age of the moon, it becomes possible to suppress or promote changes in the living activities of the human being, which are said to be related with the age of the moon.

The present invention may be applied to a variety of electronic apparatus other than the television receiver 10 or the DVD player 20. For example, on a day of the full moon, an air conditioner may be set to a lower temperature or the water from a water heater may also be set to a lower temperature to calm the frame of mind of the human being. The light from the electric lights may also be dimmed for the same purpose.

In the foregoing, the image or audio processing is carried out such as to calm or excite the frame of mind of the user when the moon age is nearing the full moon or the new moon, respectively. Alternatively, control may be exercised in a reverse fashion, that is, such as to excite or calm the frame of mind of the user when the moon age is nearing the full moon or the new moon, respectively.

It should be noted that the present invention is not limited to the above embodiment which has so far been made with reference to the drawings and, as may be apparent to those skilled in the art, a variety of changes, substitutions or equivalents may be attempted without departing from the scope of the invention as defined in the claims.

1. An electronic apparatus the operations of which are controlled electronically, said apparatus comprising
main operating means for performing a specified operation consistent with the usage and application of said electronic apparatus;
main control means for controlling said main operating means;
display means including a main operation display area for demonstrating the operating state of said main operating means and a moon image display area for demonstrating a moon image consistent with the age of the moon; and
display control means for demonstrating the operation of said main operating means, output from said main control means, in said main operation display area, and for demonstrating the moon image consistent with the age of the moon in said moon image display area.

2. The electronic apparatus according to claim 1 further comprising
a moon age calendar for storage of the age of the moon and timepiece means for timing the current date and time;
said display control means acquiring the age of the moon consistent with the current date and time from said moon age calendar.

3. The electronic apparatus according to claim 1 further comprising
communication control means for establishing connection to an external network;
said display control means acquiring the age of the moon from said external network through said communication control means.

4. An electronic apparatus the operations of which are controlled electronically, said apparatus comprising
main operating means for performing a specified operation consistent with the usage of said electronic apparatus;
moon age acquisition means for acquiring the age of the moon; and
control means for controlling the operation of said main operating means in keeping with said age of the moon.

5. The electronic apparatus according to claim 4 wherein said main operating means is image processing means and wherein the operations carried out by said image processing means responsive to control by said control means include edge adjustment and contrast adjustment.

6. The electronic apparatus according to claim 4 wherein said main operating means is audio processing means and wherein the operations carried out by said audio processing means responsive to control by said control means include speech rhythm adjustment and high range enhancement.

7. The electronic apparatus according to claim 4 wherein said main control means is light emitting means furnishing light as illumination; and wherein
the operation carried out by said light emitting means responsive to control by said control means includes light volume adjustment.
